(19) United States
(12) Patent Application Publication
(10) Pub. No.: US 2016/0172097 A1
(43) Pub. Date: Jun. 16, 2016

(54) ELECTRONIC COMPONENT AND METHOD OF MANUFACTURING THE SAME

(71) Applicant: SAMSUNG ELECTRO-MECHANICS CO., LTD., Suwon-Si (KR)

(72) Inventor: Dong Jin JEONG, Suwon-Si (KR)

(21) Appl. No.: 14/936,502

(22) Filed: Nov. 9, 2015

(30) Foreign Application Priority Data
Dec. 12, 2014 (KR) 10-2014-0179807

(51) Int. Cl. H01F 27/28; H01F 41/02; H01F 41/04; H01F 27/245

(52) U.S. Cl. CPC H01F 27/2804; H01F 27/245; H01F 41/0233; H01F 41/041

(57) ABSTRACT

An electronic component includes a magnetic body having a surface step formed on at least one surface of the magnetic body; a coil pattern disposed in the magnetic body; and a filling part reducing a thickness of the surface step by filling at least a relatively thin portion of a region in the magnetic body.

### CROSS-REFERENCE TO RELATED APPLICATION

This application claims the benefit of priority to Korean Patent Application No. 10-2014-0179807, filed on Dec. 12, 2014 with the Korean Intellectual Property Office, the entirety of which is incorporated herein by reference.

### BACKGROUND

The present disclosure relates to an electronic component and a method of manufacturing the same.

An inductor, an electronic component, is a representative passive element configuring an electronic circuit, together with a resistor and a capacitor, to remove noise.

A thin film type inductor is manufactured by forming coil patterns by a plating process, hardening a magnetic powder-resin composite in which a magnetic powder and a resin are mixed with each other to manufacture a magnetic body, and then forming external electrodes on outer surfaces of the magnetic body.

In the case of a thin film type inductor, in accordance with recent changes such as increasing complexity, multifunctionalization, slimming, or the like of a device, attempts to slim inductors continue. Thus, technology in which high performance and reliability can be secured despite a trend toward slimness of electronic components is required.

### SUMMARY

One aspect of the present disclosure may provide an electronic component having a reduction in problems such as breakage defects, mounting defects, and the like which may occur when a relatively thin electronic component is manufactured by reducing a step which may occur on a surface of the body, and a method for efficiently manufacturing the electronic component.

According to an aspect of the present disclosure, an electronic component comprises a magnetic body having a surface step formed on at least one surface of the magnetic body; a coil pattern disposed in the magnetic body; and a filling part reducing a thickness of the surface step by filling at least a portion of relatively thin region in the magnetic body.

The filling part may be made of the same material as a material of the magnetic body.

The filling part may be made of a material different from a material of the magnetic body.

The filling part may comprise a resin part.

The filling part may further comprise metal particles dispersed in the resin part.

The filling part may further comprise ferrite particles dispersed in the resin part.

The filling part may comprise dielectric particles dispersed in the resin part.

The magnetic body may have a thickness less than 0.6 mm.

The filling part may have a thickness more than 0.1 mm.

The thickness of the surface step to which the filling part has been applied may be less than 0.05 mm.

The thickness of the surface step may correspond to a region of the magnetic body in which the coil pattern is formed.

The coil pattern may comprise a first coil pattern disposed on a first surface of an insulating substrate and a second coil pattern disposed on a second surface of the insulating substrate opposing the first surface of the insulating substrate.

According to another aspect of the present disclosure, a method of manufacturing an electronic component comprises steps of: forming coil patterns on an insulating substrate; providing magnetic sheets on an upper surface and a lower surface of the insulating substrate on which the coil patterns are formed, to form a magnetic body; and forming a filling part by filling at least a portion of a relatively thin region in the magnetic body to reduce a surface step of the magnetic body.

The method may further comprise, after the step of forming the filling part, a step of curing the magnetic body and the filling part together with each other.

The method may further comprise, before the step of forming the filling part, a step of curing the magnetic body.

The coil patterns may be formed by a plating process.

### BRIEF DESCRIPTION OF DRAWINGS

The above and other aspects, features and advantages of the present disclosure will be more clearly understood from the following detailed description taken in conjunction with the accompanying drawings, in which:

FIG. 1 is a schematic perspective view illustrating an electronic component according to an exemplary embodiment in the present disclosure so that coil patterns of the electronic component are visible;

FIG. 2 is a cross-sectional view taken along line I-I′ of FIG. 1; and

FIG. 3 is a schematic process flow chart describing a manufacturing process of an electronic component according to an exemplary embodiment in the present disclosure.

### DETAILED DESCRIPTION

Hereinafter, embodiments of the present disclosure will be described in detail with reference to the accompanying drawings.

The disclosure may, however, be embodied in many different forms and should not be construed as being limited to the embodiments set forth herein. Rather, these embodiments are provided so that this disclosure will be thorough and complete, and will fully convey the scope of the disclosure to those skilled in the art.

In the drawings, the shapes and dimensions of elements may be exaggerated for clarity, and the same reference numerals will be used throughout to designate the same or like elements.

Electronic Component

Hereinafter, an electronic component according to an exemplary embodiment, particularly, a thin film type inductor will be described as an example. However, the electronic component according to the exemplary embodiment is not limited thereto.

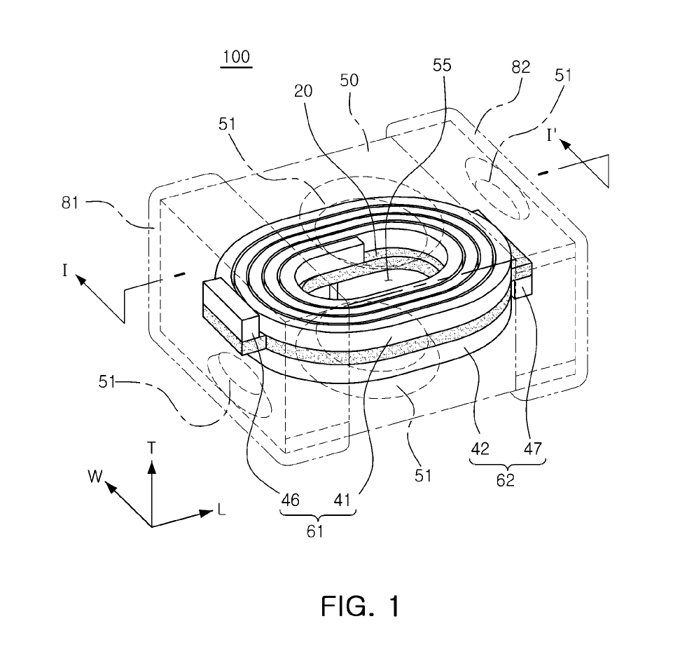

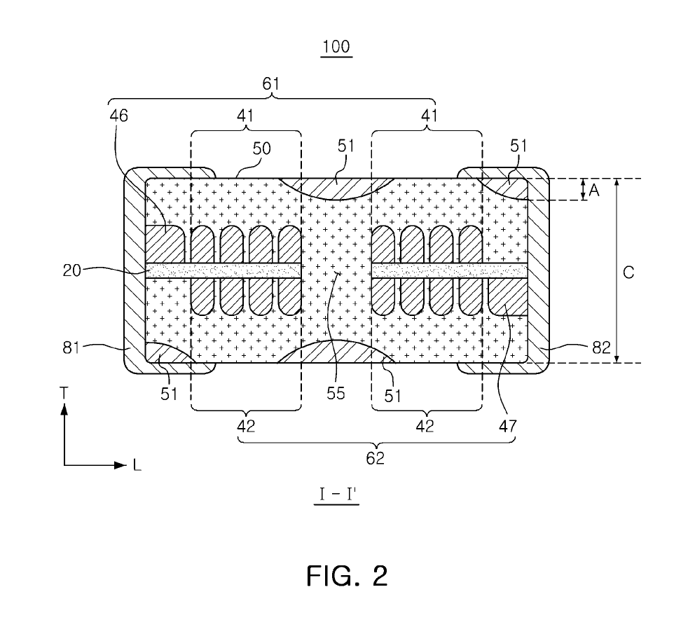

FIG. 1 is a schematic perspective view illustrating an electronic component according to an exemplary embodiment so that internal coil patterns of the electronic component are visible, and FIG. 2 is a cross-sectional view taken along line I-I′ of FIG. 1. Referring to FIGS. 1 and 2, as an example of an electronic component, a thin film type inductor used in a power line, or the like of a power supply circuit is depicted.

The electronic component 100, according to an exemplary embodiment, may include a magnetic body 50, coil patterns 61 and 62 embedded in the magnetic body 50, filling parts 51 filling a surface step of the magnetic body 50, and first and second external electrodes 81 and 82 disposed on outer surfaces of the magnetic body 50 and connected to the coil patterns 61 and 62.

In FIG. 1, a “length” direction refers to an “L” direction of FIG. 1, a “width” direction refers to a “W” direction of FIG. 1, and a “thickness” direction refers to a “T” direction of FIG. 1.

The magnetic body 50 may form a shape of the electronic component 100 and may be formed of any material that exhibits magnetic properties. For example, the magnetic body 50 may be formed by providing ferrite or magnetic metal particles in a resin part.

As a specific example of the above-mentioned materials, the ferrite may be made of an Mn—Zn-based ferrite, an Ni—Zn-based ferrite, an Ni—Zn—Cu-based ferrite, an Mn—Mg-based ferrite, a Ba-based ferrite, an Li-based ferrite, or the like, and the magnetic body 50 may have a form in which the above-mentioned ferrite particles are dispersed in a resin such as epoxy, polyimide, or the like.

The magnetic metal particles may contain any one or more selected from the group consisting of iron (Fe), silicon (Si), chromium (Cr), aluminum (Al), and nickel (Ni). For example, the magnetic metal particles may be an Fe—Si—B—Cr based amorphous metal, but are not limited thereto. The magnetic metal particles may have a diameter of about 0.1 μm to 30 μm and the magnetic body 50 may have a form in which the above-mentioned magnetic metal particles are dispersed in the resin such as epoxy, polyimide, or the like, similar to the ferrite described above.

As illustrated in FIGS. 1 and 2, the first coil pattern 61 may be disposed on a first surface of an insulating substrate 20 disposed in the magnetic body 50, and the second coil pattern 62 may be disposed on a second surface of the insulating substrate 20 opposing the first surface of the insulating substrate 20. In this case, the first and second coil patterns 61 and 62 may be electrically connected to each other through a via (not illustrated) formed to penetrate through the insulating substrate 20.

The insulating substrate 20 may be, for example, a polypropylene glycol (PPG) substrate, a ferrite substrate, a metal based soft magnetic substrate, or the like. The insulating substrate 20 may have a through-hole formed in a central portion thereof so as to penetrate through the central portion thereof, wherein the through-hole may be filled with a magnetic material to form a core part 55. As such, the core part 55 filled with the magnetic material maybe formed, thereby improving performance of the thin film type inductor.

The first and second coil patterns 61 and 62 may each be formed in a spiral shape and may include internal coil parts 41 and 42 serving as a main region of a coil, and lead parts 46 and 47 connected to ends of the internal coil parts 41 and 42 and exposed to surfaces of the magnetic body 50. The lead parts 46 and 47 may be formed by extending one end portion of each of the internal coil parts 41 and 42, and may be exposed to surfaces of the magnetic body 50 so as to be connected to the external electrodes 81 and 82 disposed on the outer surfaces of the magnetic body 50.

The first and second coil patterns 61 and 62 and a via (not illustrated) may be formed of a material including a metal having excellent electrical conductivity, and may be formed of silver (Ag), palladium (Pd), aluminum (Al), nickel (Ni), titanium (Ti), gold (Au), copper (Cu), platinum (Pt), or alloys thereof. As an example of a process of forming the first and second coil patterns 61 and 62 in a thin film shape, the first and second coil patterns 61 and 62 may be formed by performing an electroplating method. However, other processes known in the art may also be used as long as they show a similar effect.

According to the present exemplary embodiment, filling parts 51 may be formed on surfaces of the magnetic body 50, and particularly, the filling parts 51 may be formed to reduce a surface step by filling at least a portion of a relatively thin region on surfaces of the magnetic body 50. The magnetic body 50 may cause the surface step by the coil patterns 61 and 62 disposed therein to form during a process of manufacturing the magnetic body 50, and the above-mentioned surface step may be further increased as the magnetic body 50 is manufactured to be thin. Here, a reference of a small thickness, for example, a thickness C of the magnetic body 50, may be formed to be less than approximately 0.6 mm. When the surface step occurs in the magnetic body 50, several problems may be caused in the manufacturing process. For example, breakage defects of corners may occur during a process of cutting the magnetic body 50 into respective electronic components having a size corresponding thereto, an electronic component may move due to a bonding defect at the time when the electronic component is mounted may occur (thereby, exposing the internal coil patterns due to a mis-cutting of the magnetic body 50), or the like.

Although the description above describes a case in which the surface step has a form in which a region corresponding to a region in which the coil patterns 61 and 62 are formed in the magnetic body 50 is formed to be thicker than other regions, the form of the surface step is not limited thereto. For instance, the surface step of the magnetic body 50 may also be formed by other means independent of the positions of the coil patterns 61 and 62, or the like, such as a physical property of the magnetic body 50, natural factors, or the like. Even in these cases, the filling parts 51 may be usefully implemented.

In order to significantly reduce problems due to the surface step, the present exemplary embodiment may adopt the filling unit 51, and the filling unit 51 may be obtained by various materials capable of performing the above-mentioned function (step recovery) and various processes. Specifically, the filling parts 51 may be formed of the same material as the magnetic body 50, for example, a material including metal particles or ferrite particles dispersed in the resin part.

Conversely, the filling parts 51 may also be formed of a material different from that of the magnetic body 50, if necessary or in view of process convenience. For example, the filling parts 51 may be formed of dielectric particles dispersed in the resin part. In addition, the filling parts 51 may also be formed using only a resin having high viscosity without separately including the particles dispersed in the resin part.

While taking account of the thickness of the magnetic body 50 and a function of alleviating the surface step, each of the filling parts 51 may have a thickness A which is larger than about 0.1 mm. In addition, a thickness of each of the surface steps of surfaces (an upper surface and a lower surface in FIG. 2) of the magnetic body 50 to which the filling parts 51 have been applied may be less than 0.05 mm. The basis explaining this result will be described with reference to Table 1.

Inventors herein have inspected a defect rate according to a change in the surface step, wherein the surface step has been adjusted by changing the thicknesses of the filling parts 51.

TABLE 1

| | | Corner Breakage | Exposure Defect |
|---|---|---|---|
| | Surface Step (mm) | Defect Rate (%) | Rate (%) |
| 1 | 0.3 | 100 | 100 |
| 2 | 0.2 | 100 | 50 |
| 3 | 0.1 | 50 | 30 |
| 4 | 0.05 | 0 | 0 |
| 5 | 0.03 | 0 | 0 |
| 6 | 0.01 | 0 | 0 |
| 7 | 0 | 0 | 0 |

It may be seen from the results of Table 1 that corner breakage or exposure defects of the internal coils (mounting defect) maybe substantially removed in a case in which the surface step is formed to a level smaller than 0.05 mm.

Method of Manufacturing Electronic Component

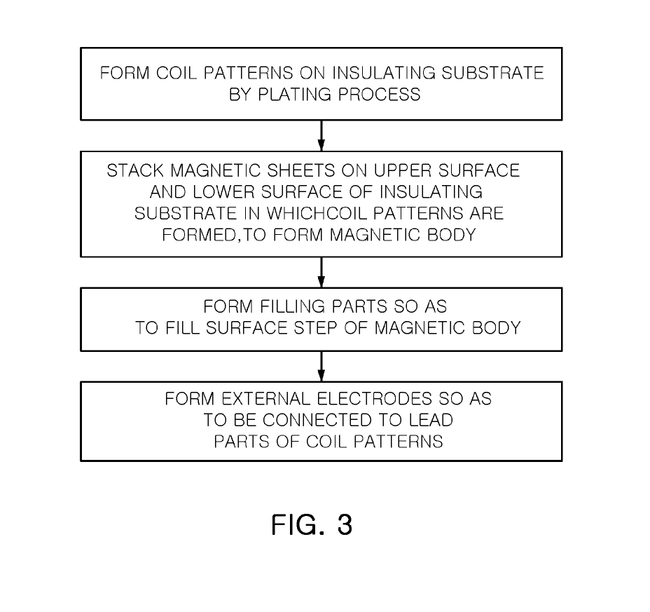

FIG. 3 is a process flow chart schematically describing a manufacturing process of an electronic component according to an exemplary embodiment. The method of manufacturing an electronic component in FIG. 3 will be described with reference to FIGS. 1 and 2.

First, coil patterns 61 and 62 may be formed on an insulating substrate 20. Here, a plating may be, but is not necessarily, used. As described above, the coil patterns 61 and 62 may include the internal coil parts 41 and 42 having a spiral shape, and the lead parts 46 and 47 formed by extending one end portion of each of the internal coil parts 41 and 42.

Although not illustrated in FIGS. 1 and 2, in order to further protect the coil patterns 61 and 62, an insulating film (not illustrated) coating the coil patterns 61 and 62 may be formed, wherein the insulating film may be formed by a known method such as a screen printing method, an exposure and development method of a photo-resist (PR), a spray applying method, or the like.

The magnetic sheets may be stacked on upper and lower surfaces of the insulating substrate 20 on which the coil patterns 61 and 62 are formed, and the stacked magnetic sheets may then be compressed and cured to form the magnetic body 50. The magnetic sheets may be manufactured in a sheet shape by preparing slurry by mixtures of magnetic metal powder, and organic materials such as a binder, a solvent, and the like, applying the slurry at a thickness of several tens of micrometers onto carrier films by a doctor blade method, and then drying the slurry.

A central portion of the insulating substrate 20 may be removed by performing mechanical drilling, laser drilling, sandblasting, punching, or the like to form a core part hole, and the core part hole may be filled with the magnetic material in the process of stacking, compressing and curing the magnetic sheets to form the core part 55.

As described above, particularly, due to an influence of coil patterns 61 and 62 in the magnetic body 50, the magnetic body 50 may cause the surface step, and the filling parts 51 may be formed by filling at least a portion of a region having a relatively thin thickness in the magnetic body 50 in order to reduce the formation of the surface step. In this case, a material the same as that forming the filling parts 51 is not particularly limited, and the same material as the magnetic body 50 or a material different from the magnetic body 50 may be used, if necessary.

The filling parts 51 may be cured together with the magnetic body 50 or cured separately from the magnetic body 50. For instance, after the filling parts 51 are formed, the magnetic body 50 and the filling parts 51 may be cured together with each other or the magnetic body 50 may also be cured in advance before the filling parts 51 are formed. A curing timing of the filling parts 51 may be appropriately selected according to the material the same as that forming the filling parts 51.

The first and second external electrodes 81 and 82 may be formed on the outer surfaces of the magnetic body 50 so as to be connected, respectively, to the lead parts 46 and 47 exposed to surfaces of the magnetic body 50. The external electrodes 81 and 82 maybe formed of a paste containing a metal having excellent electrical conductivity, such as a conductive paste containing nickel (Ni), copper (Cu), tin (Sn), or silver (Ag), or alloys thereof. In addition, plated layers (not illustrated) may be further formed on the external electrodes 81 and 82. The plated layers may contain one or more selected from a group consisting of nickel (Ni), copper (Cu), and tin (Sn). For example, a nickel (Ni) layer and a tin (Sn) layer may be sequentially formed.

A description of features overlapping those of the electronic component according to the exemplary embodiment described above except for the above-mentioned description will be omitted.

As set forth above, according to an exemplary embodiment, the electronic component having the reduction in problems such as breakage defects, mounting defects, and the like which may be caused at the time when the slimmed electronic component having a relatively thin thickness is manufactured may be provided, and further, a method having efficient manufacturing of the electronic component may be provided.

While exemplary embodiments have been shown and described above, it will be apparent to those skilled in the art that modifications and variations could be made without departing from the scope of the present invention as defined by the appended claims.

What is claimed is:

1. An electronic component comprising:
a magnetic body having a surface step formed on at least one surface of the magnetic body;
a coil pattern disposed in the magnetic body; and
a filling part reducing a thickness of the surface step by filling at least a portion of a relatively thin region in the magnetic body.

2. The electronic component of claim 1, wherein the filling part is made of the same material as a material of the magnetic body.

3. The electronic component of claim 1, wherein the filling part is made of a material different from a material of the magnetic body.

4. The electronic component of claim 1, wherein the filling part comprises a resin part.

5. The electronic component of claim 4, wherein the filling part further comprises metal particles dispersed in the resin part.

6. The electronic component of claim 5, wherein the filling part further comprises ferrite particles dispersed in the resin part.

7. The electronic component of claim 5, wherein the filling part comprises dielectric particles dispersed in the resin part.

8. The electronic component of claim 1, wherein the magnetic body has a thickness less than 0.6 mm.

9. The electronic component of claim 1, wherein the filling part has a thickness more than 0.1 mm.

10. The electronic component of claim 1, wherein the thickness of the surface step to which the filling part has been applied is less than 0.05 mm.

11. The electronic component of claim 1, wherein the thickness of the surface step corresponds to a region of the magnetic body in which the coil pattern is formed.

12. The electronic component of claim 1, wherein the coil pattern comprises a first coil pattern disposed on a first surface of an insulating substrate and a second coil pattern disposed on a second surface of the insulating substrate opposing the first surface of the insulating substrate.

13. A method of manufacturing an electronic component, the method comprising steps of:
forming coil patterns on an insulating substrate;
providing magnetic sheets on an upper surface and a lower surface of the insulating substrate on which the coil patterns are formed, to form a magnetic body; and
forming a filling part by filling at least a portion of a relatively thin region in the magnetic body to reduce a surface step of the magnetic body.

14. The method of claim 13, further comprising, after the step of forming the filling part, a step of curing the magnetic body and the filling part together with each other.

15. The method of claim 13, further comprising, before the step of forming the filling part, a step of curing the magnetic body.

16. The method of claim 13, wherein the coil patterns are formed by a plating process.
